(19) United States
(12) Patent Application Publication
(10) Pub. No.: US 2006/0140221 A1
(43) Pub. Date: Jun. 29, 2006

(54) Reproduction apparatus and decoding control method

(75) Inventors: Masahiro Yamada, Nishitama-gun (JP); Keiko Hirayama, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/294,458

(22) Filed: Dec. 6, 2005

(30) Foreign Application Priority Data
Dec. 27, 2004 (JP) 2004-377027

(51) Int. Cl. H04L 12/26; H04J 3/22; H04J 3/18; H04J 3/06; H04L 1/00; H04J 3/16

(52) U.S. Cl. 370/503; 370/465; 370/229; 370/477

(57) ABSTRACT

A reproduction apparatus includes a unit which receives a stream that is transferred from a server, a buffer which stores the received stream, a decoder which executes a decoding process for reading out the received stream from the buffer and decoding the received stream, a clock generator which generates a clock signal which determines a speed of the decoding process, a unit which determines whether the received stream is a real-time stream or a non-real-time stream, and a unit which executes a process for varying a frequency of the clock signal in accordance with a fill level of the buffer if the received stream is the real-time stream, and executes a process for setting the frequency of the clock signal at a fixed value if the received stream is the non-real-time stream.

### CROSS-REFERENCE TO RELATED APPLICATIONS

This application is based upon and claims the benefit of priority from prior Japanese Patent Application No. 2004-377027, filed Dec. 27, 2004, the entire contents of which are incorporated herein by reference.

### BACKGROUND OF THE INVENTION

1. Field of the Invention

The present invention relates to a reproduction apparatus that reproduces compression-encoded data, and to a decoding control method that is applicable to the reproduction apparatus.

2. Description of the Related Art

In recent years, there has been developed a system wherein a data stream, such as digitally compression-encoded audio/video (AV), is transmitted from a server to a client over a network. In this system, for example, a real-time stream, such as broadcast data, is transmitted from the server to the client over the network.

In addition, recently, there is a demand for such a technique that not only a real-time stream such as broadcast data, but also a non-real-time stream that can be read out of a storage medium at an arbitrary rate, is transmitted from a server to a client via a network.

Jpn. Pat. Appln. KOKAI Publication No. 2003-134468 discloses a digital signal processing apparatus that can decode both a transport stream, which is output from a tuner, and a program stream, which is read out of a storage medium. In this digital signal processing apparatus, when the transport stream is to be decoded, the decoding process is executed in sync with a clock that is adjusted on the basis of a program clock reference (PCR) that is included in the transport stream. On the other hand, when the program stream is to be decoded, the decoding process is executed in sync with another stable clock.

In the digital signal processing apparatus of Jpn. Pat. Appln. KOKAI Publication No. 2003-134468, however, the clock control method is changed in accordance with the kind of the transport stream/program stream. This apparatus is not applicable to the case where both of the stream that is output from the tuner and the stream that is read out of the storage medium are transport streams.

For example, in a case where broadcast program data that is composed of a transport stream is recorded in a storage medium, a stream that is read out of the storage medium also becomes a transport stream.

Besides, the digital signal processing apparatus of Jpn. Pat. Appln. KOKAI Publication No. 2003-134468 is designed to decode streams from a tuner and a storage medium, which are provided in the digital signal processing apparatus. No consideration is given to decoding a transport stream/program stream that is sent from a server over a network.

In a system in which a stream is transmitted via a network, the clock on a transmission apparatus side, which transmits a stream, is independent from the clock on a reception apparatus side which decodes the stream. It is thus necessary to execute a clock control process for synchronizing the clock on the reception apparatus side with the clock on the transmission apparatus side. However, it is practically difficult to make use of clock adjustment that uses the above-mentioned program clock reference (PCR). The reason is that in the case of data transmission over a network, a delay fluctuation causes such PCR jitter that a delay time differs between packets each including PCR.

Thus, in the system in which a stream is transmitted via a network, it is necessary to execute a clock control process for adjusting the reception apparatus-side clock in accordance with the fill level (i.e. a level up to which data is filled) of a buffer provided in the transmission apparatus. If the fill level of the buffer is greater than a predetermined level, the clock rate on the receiver side is increased. On the other hand, if the fill level of the buffer is lower than the predetermined level, the clock rate on the receiver side is decreased.

If this clock control process is not executed, video/audio of a real-time stream such as broadcast data cannot normally be decoded and reproduced by the reception apparatus since an error occurs between the data transmission rate on the transmission apparatus side and the decoding rate on the reception apparatus side.

For example, if an error between the transmitter-side clock and the receiver-side clock is 30 ppm (parts per million) that is a tolerance stipulated in the MPEG (Moving Picture Experts Group), a video error and an audio error of one frame (30 msec) will occur in 1000 seconds (16 minutes).

On the other hand, if such a clock control process is always performed, AV content that is read out of the storage medium could not normally be reproduced.

In other words, since all data that constitute AV content are present in the storage medium in advance, as long as an empty area is present in the receiver-side buffer, the data is transferred from the transmitter side to the receiver side at a higher transmission rate than the normal rate of the AV content. As a result, the receiver-side buffer always stores data, the amount of which exceeds a predetermined level. In this case, the clock rate on the receiver side is accelerated, and the receiver-side clock is controlled to oscillate at a maximum value in a possible oscillation frequency range. Consequently, the AV content is reproduced at a very high rate.

### BRIEF SUMMARY OF THE INVENTION

According to an embodiment of the present invention, there is provided a reproduction apparatus that reproduces a stream including compression-encoded data, comprising: a request sending unit which sends a request instructing transfer of the stream to a server over a network; a receiving unit which receives the stream that is transferred from the server over the network; a buffer which stores the received stream; a decoder which executes a decoding process for reading out the received stream from the buffer and decoding the received stream; a clock generator which generates a clock signal which determines a speed of the decoding process; a determining unit configured to determine whether the received stream is a real-time stream, which is transmitted in real time from the server at a transmission rate corresponding to the received stream, or a non-real-time stream, which is stored in a storage medium of the server and can be transmitted from the server at a higher rate than the transmission rate corresponding to the received stream; and a clock control unit configured to execute a process for varying a frequency of the clock signal in accordance with a fill level of the buffer if the received stream is the real-time stream, and to execute a process for setting the frequency of the clock signal at a fixed value if the received stream is the non-real-time stream.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram that shows a first example of a system configuration of a reproduction apparatus according to an embodiment of the present invention;

FIG. 2 is a block diagram that shows an example of the structure of a network client process unit that is provided in the reproduction apparatus shown in FIG. 1;

FIG. 3 is a block diagram that shows an example of the structure of an MPEG decoder that is provided in the reproduction apparatus shown in FIG. 1;

FIG. 4 is a block diagram that shows an example of the structure of an oscillation frequency control voltage generator that is provided in the reproduction apparatus shown in FIG. 1;

FIG. 5 is a block diagram that shows an example of the structure of a clock generator that is provided in the reproduction apparatus shown in FIG. 1;

FIG. 6 is a flow chart that shows a first example of the procedure of a clock control process that is applied to the reproduction apparatus shown in FIG. 1;

FIG. 7 is a flow chart that shows a second example of the procedure of the clock control process that is applied to the reproduction apparatus shown in FIG. 1;

FIG. 8 shows an example of the data structure of an IP packet that is received by the reproduction apparatus shown in FIG. 1;

FIG. 9 is a block diagram that shows a second example of the system configuration of the reproduction apparatus according to the embodiment of the present invention;

FIG. 10 is a block diagram that shows an example of the structure of a TS reproduction process unit that is provided in the reproduction apparatus shown in FIG. 9;

FIG. 11 is a block diagram that shows an example of the structure of an MPEG decoder that is provided in the reproduction apparatus shown in FIG. 9;

FIG. 12 is a flow chart that shows a third example of the procedure of the clock control process that is applied to the reproduction apparatus shown in FIG. 9;

FIG. 13 is a block diagram that shows a third example of the system configuration of the reproduction apparatus according to the embodiment of the present invention; and

FIG. 14 is a flow chart that shows a fourth example of the procedure of the clock control process that is applied to the reproduction apparatus shown in FIG. 13.

### DETAILED DESCRIPTION OF THE INVENTION

An embodiment according to the present invention will now be described with reference to the accompanying drawings.

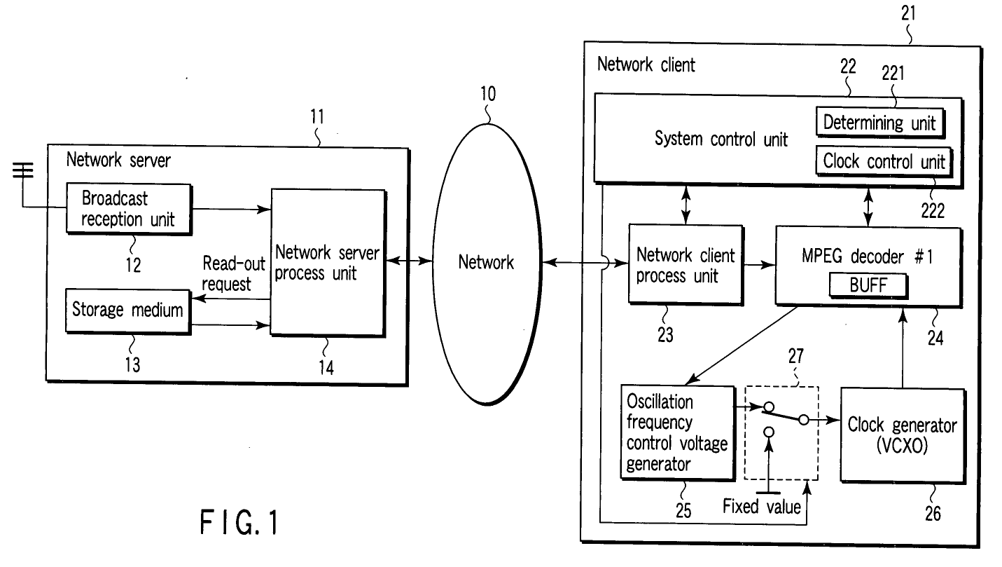

FIG. 1 shows a configuration of a reproduction apparatus according to an embodiment of the present invention. The reproduction apparatus is realized as a network client 21 that can execute communication with a network server 11. The network server 11 and network client 21 are connected to a network 10 such as a household LAN (Local Area Network). The network server 11 functions as a server of a home network system. The network client 21 functions as a client terminal of the home network system.

The network server 11, as shown in FIG. 1, comprises a broadcast reception unit 12, a storage medium 13 and a network server process unit 14. The broadcast reception unit 12 is a reception apparatus that receives broadcast program data such as a TV program. The broadcast reception unit 12 receives a digital broadcast signal such as a terrestrial digital broadcast signal, and extracts from the digital broadcast signal a transport stream (TS) that corresponds to broadcast program data of an arbitrary channel. The transport stream includes compression-encoded broadcast program data. A TS packets that constitutes the transport stream are sent out from the broadcast reception unit 12 in real time to the network server process section 14 at the same timing as the timing of transmission from a broadcast station. In other words, the transport stream that is output from the broadcast reception section 12 is a real-time stream that is transferred in real time to the network client 21 via the network 10 at a transmission rate corresponding to the reproduction rate (frame rate) of the transport stream.

The storage medium 13 is a storage device that stores compression-encoded AV content. The storage medium 13 is composed of, e.g. a hard disk drive (HDD) or a DVD (Digital Versatile Disc) drive. Broadcast program data that is received by the broadcast reception unit 12 may be recorded in the storage medium 13. A stream of AV content, which is stored in the storage medium 13, is a non-real-time stream that can be read out of the storage medium 13 at an arbitrary rate, regardless of the normal transmission rate corresponding to the reproduction speed of the stream of the AV content. If a request is received from the network client 21, the stream of AV content stored in the storage medium 13 is transmitted to the network client 21 via the network 10 at a higher rate than the normal transmission rate of the AV content.

The network server process unit 14 functions as, e.g. an HTTP (Hyper Text Transfer Protocol) server. Upon request from the network client 21, the network server process unit 14 transfers currently broadcast content, which is received by the broadcast reception unit 12, or content stored in the storage medium 13, to the network client 21 over the network 10.

By the request from the network client 21, the transfer of the stream of to-be-reproduced content is demanded in units of a certain data size. In the case where transfer of currently broadcast content is requested, each time the network server process unit 14 receives a TS packet from the broadcast reception unit 12, the network server process unit 14 delivers the received TS packet to the network 10. Thereby, each of the TS packets is sent to the network 10 in real time at the same timing as the timing of transmission from the broadcast station. This sending process is repeated, for example, until the total data size of all sent TS packets becomes equal to the requested data size.

On the other hand, when content that is stored in the storage medium 13 is requested, the network server process unit 14 reads out a stream of the requested content (transport stream TS or program stream PS) from the storage medium 13. For example, a video recording format (VR format) is usable as the program stream. Since all the packets (TS packets or PS packets) that constitute the stream of the requested content are already present in the storage medium 13, the packet group of the requested data size is immediately read out to the network server process unit 14. The network server process unit 14 successively transfers the read-out packets to the network client 21 via the network 10. Thereby, the packets that constitute the stream, the transfer of which has been requested, is immediately transferred to the network client 21, regardless of the reproduction timing of each packet of the stream.

Each packet that is transmitted over the network 10 is an IP packet. Thus, each TS/PS packet is converted to the IP packet. The TS/PS packet is stored in a payload part of the IP packet.

In the description below, assume that a stream that is read out of the storage medium 13 is a transport stream.

The network client 21 is an apparatus that reproduces a stream including compression-encoded AV data. The network client 21 comprises a system control unit 22, a network client process unit 23, an MPEG (Moving Picture Experts Group) decoder (#1) 24, an oscillation frequency control voltage generator 25, an oscillation frequency control switch 27, and a clock generator 26.

The system control unit 22 controls the operation of the network client 21. The system control unit 22 includes a determining unit 221 and a clock control unit 222. The determining unit 221 has a function of determining whether the stream transferred from the network server 11 is a real-time stream such as broadcast data, or a non-real-time stream that is read out of the storage medium 13 of the network server 11. The clock control unit 222 has a function of switching the method of controlling the clock generator 26, on the basis of the determination result relating to the real-time stream/non-real-time stream.

The network client process unit 23 executes communication with the network server 11 via the network 10. The stream that is transferred from the network server 11 is received by the network client process unit 23. The MPEG decoder (#1) 24 decodes the stream that is received by the network client process unit 23. The MPEG decoder (#1) 24 includes a buffer (BUFF) that temporarily stores the received stream, and a decoding process unit that reads out the stream from the buffer (BUFF) and decodes the stream.

The oscillation frequency control voltage generator 25 generates an oscillation frequency control voltage that is to be supplied to the clock generator 26, in accordance with a fill level (FILL level) of the buffer (BUFF) within the MPEG decoder (#1) 24. The fill level of the buffer is detected, for example, by the system control unit 22. The fill level of the buffer is a value indicative of the level up to which the buffer is filled with the received stream. The fill level of the buffer can be expressed by a relative value indicative of the ratio at which the buffer is filled, or an absolute value indicative of the remaining available capacity in the buffer. An absolute value that is indicative of the amount of data stored in the buffer may be used as a fill level.

If the fill level of the buffer exceeds a reference value, the value of the oscillation frequency control voltage, which is output from the oscillation frequency control voltage generator 25, rises. On the other hand, if the fill level of the buffer lowers below a reference value, the value of the oscillation frequency control voltage, which is output from the oscillation frequency control voltage generator 25, decreases.

Under the control of the clock control unit 222 of the system control unit 22, the oscillation frequency control switch 27 switches the oscillation frequency control voltage, which is supplied to the clock generator 26, between an output value from the oscillation frequency control voltage generator 25 and a fixed value. The clock generator 26 generates a clock signal that determines the speed of the decoding operation of the MPEG decoder (#1) 24. The clock generator 26 is constructed using a voltage-controlled crystal oscillator (VCXO). The oscillation frequency of the clock generator 26 varies depending on the oscillation frequency control voltage that is input to the clock generator 26. As the value of the oscillation frequency control voltage increases, the oscillation frequency of the clock generator 26 becomes higher, and the frequency of the clock signal increases.

In the case where the received stream is a real-time stream from the broadcast reception unit 12, the oscillation frequency control switch 27 selects the output value of the oscillation frequency control voltage generator 25 under the control of the clock control unit 222 of the system control unit 22. Thereby, the frequency of the clock signal from the clock generator 26 is adjusted in accordance with the current fill level of the buffer (BUFF) so that the fill level of the buffer is kept within a predetermined range. It is thus possible to realize the synchronization between the transmission timing of the real-time stream from the network server 11 and the decoding operation timing of the MPEG decoder (#) 24.

On the other hand, in the case where the received stream is a non-real-time stream from the storage medium 13, the oscillation frequency control switch 27 selects the fixed value under the control of the clock control unit 222 of the system control unit 22. Thereby, the frequency of the clock signal from the clock generator 26 is kept at a fixed value, regardless of the fill level of the buffer (BUFF). Even if the fill level of the buffer (BUFF) exceeds the reference value, the frequency of the clock signal does not increase, and it is possible to prevent such a problem from occurring that the decoding operation speed of the MPEG decoder (#1) 24 is accelerated.

As has been described above, in the present embodiment, the clock control method is automatically changed, depending on whether the stream that is transferred via the network 10 is a real-time stream such as currently broadcast program data, which is transmitted in real time from the server 11 at a transmission rate corresponding to the stream, or a non-real-time that is stored in the storage medium and can be transmitted from the server 11 at a higher transmission rate than the transmission rate of the stream. Therefore, both the real-time stream and non-real-time stream can correctly be reproduced.

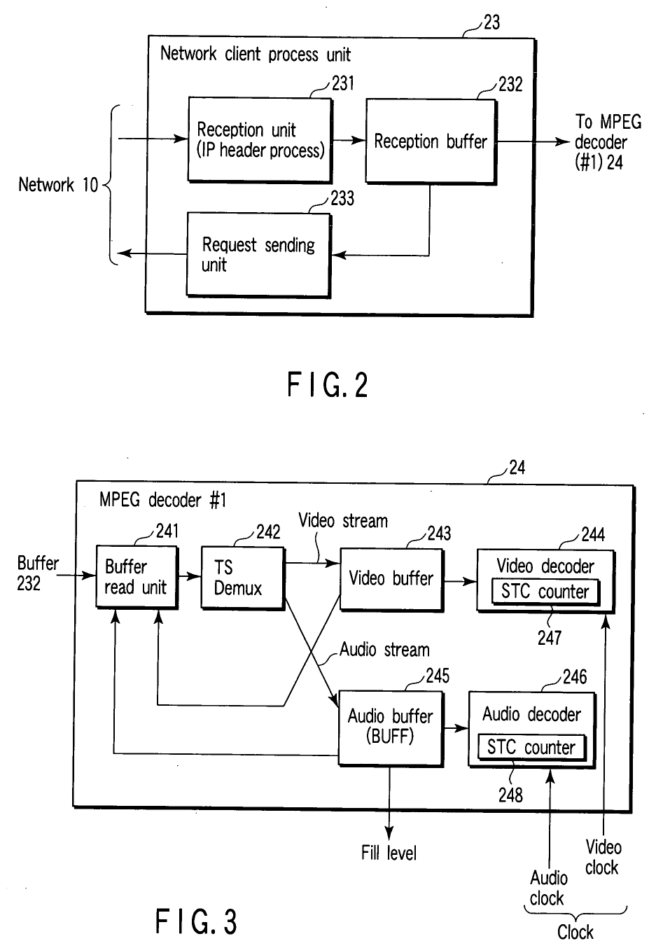

FIG. 2 shows an example of the structure of the network client process unit 23.

The network client process unit 23 comprises a reception unit 231, a reception buffer 232 and a request sending unit 233. The reception unit 231 receives IP packets from the network 10. In this case, the reception unit 231 analyzes a header of the received IP packet, and discriminates whether the received IP packet is an IP packet that includes, as a transfer-destination address, an IP address assigned to the network client 21. If the received IP packet is the IP packet that includes, as the transfer-destination address, the IP address assigned to the network client 21, the reception unit 231 stores a TS packet, which is included in a payload portion of the IP packet, in the reception buffer 232. The request sending unit 233 sends a request, which instructs transfer of to-be-reproduced data, to the network server 11 via the network 10. This request includes information that designates the title of content of to-be-reproduced data, and information that designates a transfer data size. The request is sent, for example, when the reception buffer 232 has a predetermined available remaining capacitance.

FIG. 3 shows an example of the structure of the MPEG decoder (#1) 24.

The MPEG decoder (#1) 24 comprises a buffer read unit 241, a demultiplexer (TS Demux) 242, a video buffer 243, a video decoder 244, an audio buffer 245, and an audio decoder 246.

The buffer read unit 241 reads out a transport stream from the reception buffer 232 of the network client process unit 23, and delivers it to the demultiplexer (TS Demux) 242. The read-out of the transport stream from the reception buffer 232 is executed, for example, when each of the audio buffer 245 and audio decoder 246 has a predetermined available remaining capacity.

The demultiplexer (TS Demux) 242 executes a process for separating the transport stream into video data (video stream) and audio data (audio stream). This separating process is executed, for example, in units of a TS packet. The video data is stored in the video buffer 243, and the audio data is stored in the audio buffer 245.

The video decoder 244 reads out the video data from the video buffer 243 and decodes it. The video decoder 244 receives a video clock as the aforementioned clock signal, and executes a video data decoding process in sync with the video clock. The video decoder 244 includes an STC (System Time Clock) counter 247 that executes a counting operation in sync with the video clock. The timing of the decoding process of the video decoder 244 is controlled by the counter value of the STC counter 247.

The audio decoder 246 reads out the audio data from the audio buffer 245 and decodes it. The audio decoder 246 receives an audio clock as the aforementioned clock signal, and executes an audio data decoding process in sync with the audio clock. The audio decoder 246 includes an STC (System Time Clock) counter 248 that executes a counting operation in sync with the audio clock. The timing of the decoding process of the audio decoder 246 is controlled by the counter value of the STC counter 248.

In the MPEG decoder (#1) 24, shown in FIG. 3, the video buffer 243 and audio buffer 245 function as buffers for temporarily storing transport streams that are received from the network 10. In this embodiment, of the video buffer 243 and audio buffer 245, the audio buffer 245 is used as the aforementioned buffer (BUFF). A variation in fill level of the audio buffer 245 is used for the clock control process.

Since the video data is compression-encoded by variable-rate encoding, the data amount of the video data varies, for example, from scene to scene. Consequently, in the case where the MPEG decoder (#1) 24 is decoding the real-time stream, the fill level of the video buffer 243 varies not only due to a clock error but also due to scenes that are being reproduced. On the other hand, since the audio data is compression-encoded by fixed-bit-rate encoding, a variation of the fill level of the audio buffer 245 depends only on a clock error. Thus, by making use of the fill level of the audio buffer 245 for the clock control process, the frequency of the clock signal that determines the speed of the decoding process can be adjusted more precisely.

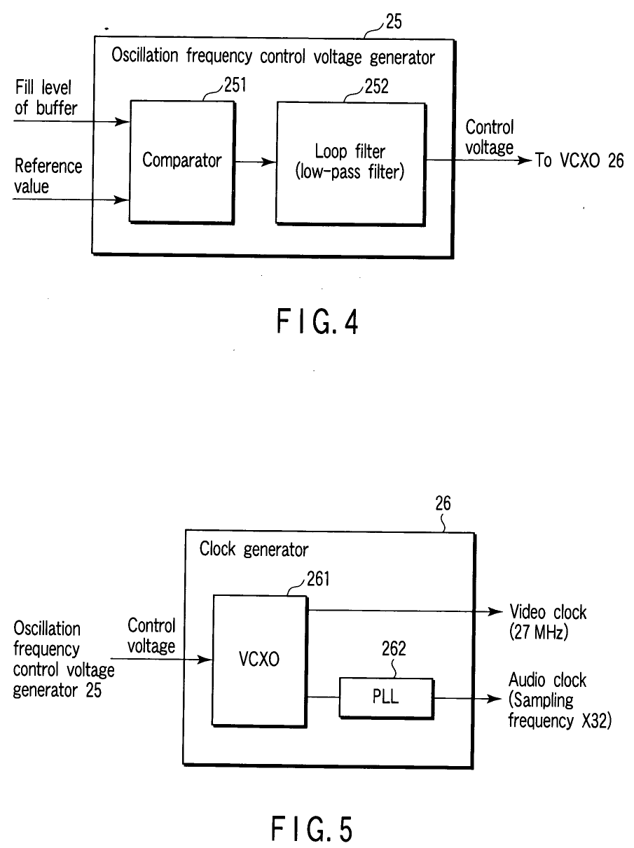

FIG. 4 shows an example of the structure of the oscillation frequency control voltage generator 25.

The oscillation frequency control voltage generator 25 comprises a comparator 251 and a loop filter 252. The comparator 251 compares the fill level of the audio buffer 245 with a reference value, and outputs a voltage corresponding to a difference value between the fill level and the reference value. For example, a value indicative of an available remaining capacity of the audio buffer 245 is usable as the fill level of the audio buffer 245. The loop filter 252 functions as a low-pass filter, and smoothes the output from the comparator 251, thereby generating an oscillation frequency control voltage.

FIG. 5 shows an example of the structure of the clock generator 26.

The clock generator 26 comprises a voltage-controlled crystal oscillator (VCXO) 261 and a PLL (Phase Locked Loop) circuit 262. The voltage-controlled crystal oscillator (VCXO) 261 is a crystal oscillator that oscillates at 27 MHz, and generates a 27 MHz clock signal as a video clock. The PLL circuit 262 generates an audio clock on the basis of the 27 MHz clock signal. The frequency of the audio clock is, for example, about 32 times as high as the sampling frequency of the audio data.

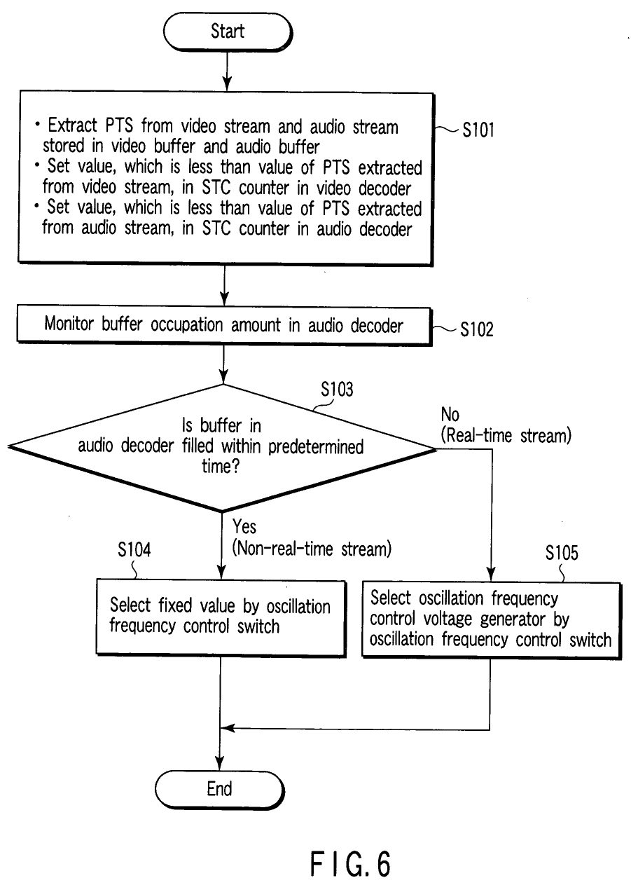

Next, referring to a flow chart of FIG. 6, a description is given of a first example of the procedure of the clock control process that is executed by the system control unit 22.

If the reception of a transport stream is started, the system control unit 22 first executes a process for initializing the STC counter 247 of the video decoder 244 and the STC counter 248 of the audio decoder 246 (step S101). In step S101, the system control unit 22 executes the following process, so as to start a decoding process in a state in which a certain amount of data is stored in each of the video buffer 243 and audio buffer 245.

The system control unit 22 extracts a PTS (Presentation Time Stamp) from each of the video stream and audio stream that are stored in the video buffer 243 and audio buffer 245. The PTS is the time information that is used in order to synchronously reproduce video data and audio data. The PTS that is included in the video stream indicates a presentation time at which the video data is to be reproduced, and the PTS that is included in the audio stream indicates a presentation time at which the audio data is to be reproduced.

The system control unit 22 sets a value, which is less than the value of the PTS extracted from the video stream by a preset value, in the STC counter 247 of the video decoder 244 as a current STC count value. In addition, the system control unit 22 sets a value, which is less than the value of the PTS extracted from the audio stream by a preset value, in the STC counter 248 of the audio decoder 246 as a current STC count value.

When the counting operation of the STC counter 247 progresses and the STC count value becomes equal to the PTS of the video data stored in the video buffer 243, the video decoder 244 executes decoding and reproduction of the associated video data. Similarly, when the counting operation of the STC counter 248 progresses and the STC count value become equal to the PTS of the audio data stored in the audio buffer 245, the audio decoder 246 executes decoding and reproduction of the associated audio data. By the process in step S101, the decoding process can be started in the state in which a certain amount of data is stored in each of the video buffer 243 and audio buffer 245.

Subsequently, the determining unit 221 of the system control unit 22 monitors the fill level of the audio buffer 245, for example, the data amount (buffer occupation amount) in the audio buffer 245, and determines whether the audio buffer 245 is to be filled within a predetermined reference time from the start of the reception of the transport stream (step S102, S103). The value of the reference time is determined in accordance with the buffer size (capacity) of the audio buffer 245. For example, in the case where the audio buffer 245 has such a buffer size as to be able to store audio data corresponding to a reproduction time of three seconds, the value of the reference time is set at a value of about 1.5 seconds.

If the stream that is being received is a real-time stream such as broadcast data, at least three seconds are needed until the audio buffer 245 is filled. Thus, the audio buffer 245 is never filled within the reference time.

On the other hand, if the received stream is a non-real-time stream which is read out of the storage medium 13, audio data is successively written in the audio buffer 245 as long as a usable area remains in the audio buffer 245. Thus, the audio buffer 245 is filled within the reference time.

If the audio buffer 245 is filled within the reference time (YES in step S103), the determining unit 221 of the system control unit 22 determines that the stream that is currently being received is the non-real-time stream from the storage medium 13. In order to prevent the decoding operation speed of the MPEG decoder (#1) 24 from being abnormally accelerated, the clock control unit 222 of the system control unit 22 selects the fixed value by the oscillation frequency control switch 27 (step S104). Thereby, the frequency of the clock signal, which is supplied to the MPEG decoder (#) 24, is kept at the fixed value.

If the audio buffer 245 is not filled within the reference time (NO in step S103), the determining unit 221 of the system control unit 22 determines that the stream that is currently being received is the real-time stream such as broadcast data. In order to adjust the frequency of the clock signal in accordance with the fill level of the audio buffer 245, the clock control unit 222 of the system control unit 22 selects the output of the oscillation frequency control voltage generator 25 by the oscillation frequency control switch 27 (step S105). Thereby, the frequency of the clock signal that is supplied to the MPEG decoder (#1) 24 is made to correspond to the transmission rate of the real-time stream from the network server 11.

Alternatively, whether the stream that is being received is a non-real-time stream or a real-time stream may be discriminated, not on the basis of whether the audio buffer 245 is actually filled, but on the basis of whether the fill level of the audio buffer 245 exceeds a reference value within a predetermined time from the beginning of the reception of the stream.

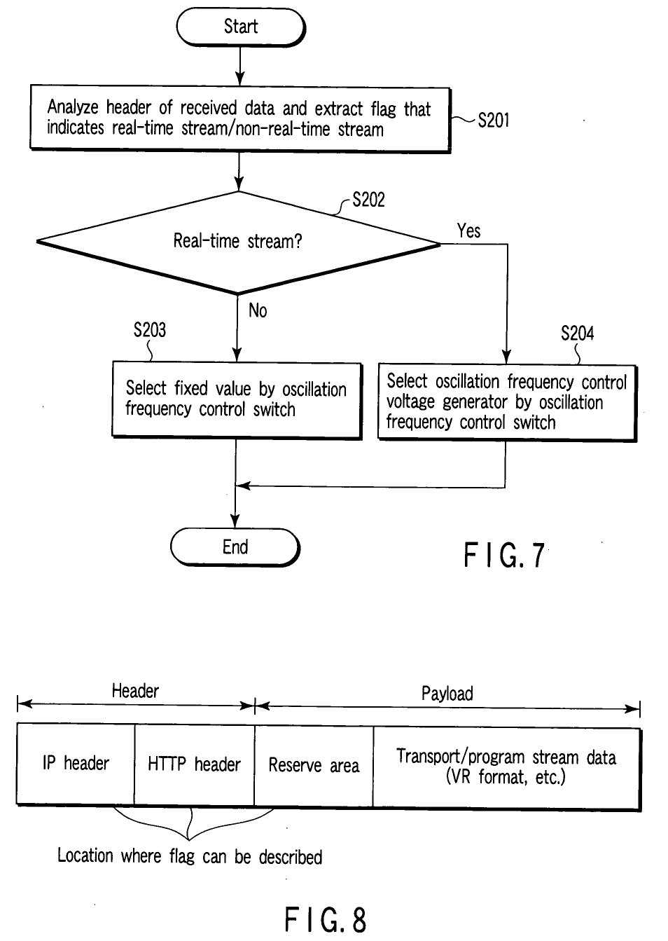

Next, referring to a flow chart of FIG. 7, a description is given of a second example of the procedure of the clock control process that is executed by the system control unit 22.

The system control unit 22 cooperates with the network client process unit 23 and analyzes the header portion of a received IP packet, thereby extracting a flag from the received IP packet (step S201). The flag is identification information that is indicative of whether the data included in the payload portion of the IP packet is a real-time stream such as broadcast data, or a non-real-time stream that is read out of the storage medium 13. The flag is inserted in each IP packet by the network server process unit 14 of the network server 11. The flag, as shown in FIG. 8, is described in an IP header portion, an HTTP header portion, or a reserve area that is provided within the payload portion.

On the basis of the flag, the determining unit 221 of the system control unit 22 determines whether the currently received stream is a real-time stream such as broadcast data or a non-real-time stream from the storage medium 13 (step S202).

If the currently received stream is the non-real-time stream from the storage medium 13 (NO in step S203), the clock control unit 222 of the system control unit 22 selects the fixed value by the oscillation frequency control switch 27 in order to prevent abnormal acceleration of the decoding operation speed of the MPEG decoder (#1) 24 (step S203). Thereby, the frequency of the clock signal, which is supplied to the MPEG decoder (#) 24, is kept at the fixed value.

On the other hand, if the currently received stream is the real-time stream such as broadcast data (YES in step S203), the clock control unit 222 of the system control unit 22 selects the output of the oscillation frequency control voltage generator 25 by the oscillation frequency control switch 27, thereby to adjust the frequency of the clock signal in accordance with the fill level of the audio buffer 245 (step S204). Thus, the frequency of the clock signal that is supplied to the MPEG decoder (#1) 24 is made to correspond to the transmission rate of the real-time stream from the network server 11.

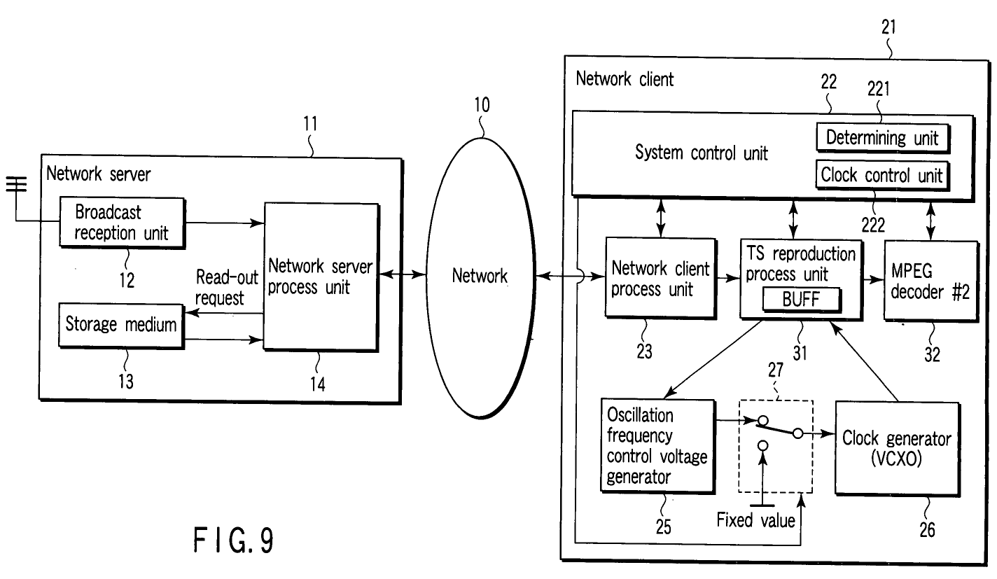

FIG. 9 shows a second example of the structure of the network client 21.

In this network client 21, the MPEG decoder (#1) 24 shown in FIG. 1 is replaced with a transport stream (TS) reproduction process unit 31 and an MPEG decoder (#2) 32. A buffer, which is provided in the transport stream (TS) reproduction process unit 31, is used as the aforementioned buffer (BUFF).

Specifically, the transport stream (TS) reproduction process unit 31 includes a buffer (BUFF) that temporarily stores a received transport stream, and a read-out unit for reading out the transport stream, which is stored in the buffer (BUFF), from the buffer (BUFF) to the MPEG decoder (#2) 32 in real time. The read-out unit operates in sync with a clock signal that is generated from the clock generator 26. The MPEG decoder (#2) 32 is configured to decode the transport stream that is transmitted in real time from the transport stream reproduction process unit 31. Each time the MPEG decoder (#2) 32 receives a TS packet from the transport stream reproduction process unit 31, it decodes the received TS packet. Thus, the speed of the decoding operation is determined by the frequency of the clock signal that is supplied to the transport stream reproduction process unit 31.

The above-described read-out unit may be provided not in the transport stream reproduction process unit 31, but in the MPEG decoder (#2) 32.

The oscillation frequency control voltage generator 25 generates an oscillation frequency control voltage that is to be supplied to the clock generator 26, in accordance with the current fill level of the buffer (BUFF) in the transport stream reproduction process unit 31, so that the fill level of the buffer (BUFF) is kept within a predetermined range. If the fill level of the buffer (BUFF) in the transport stream reproduction process unit 31 exceeds a reference value, the value of the oscillation frequency control voltage, which is output from the oscillation frequency control voltage generator 25, rises. On the other hand, if the fill level of the buffer (BUFF) in the transport stream reproduction process unit 31 lowers below the reference value, the value of the oscillation frequency control voltage, which is output from the oscillation frequency control voltage generator 25, decreases.

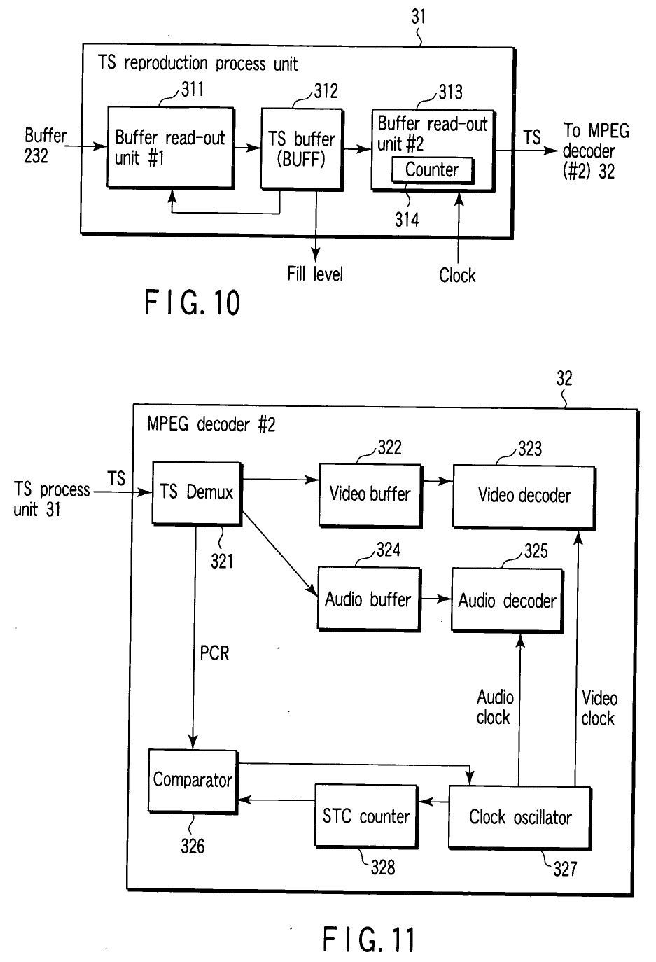

FIG. 10 shows an example of the structure of the transport stream reproduction process unit 31.

The transport stream reproduction process unit 31 comprises a first buffer read-out unit 311, a transport stream buffer (TS buffer) 312, and a second buffer read-out unit 313.

The first buffer read-out unit 311 executes a read-out process for reading out TS packets from the reception buffer 232 that is provided in the network client process unit 23, and for storing the TS packets in the TS buffer 312. This read-out process is executed when an available area is present in the TS buffer 312. Basically, each time the network client process unit 23 receives a TS packet from the network 10, the received TS packet is written in the TS buffer 312 via the network client process unit 23.

The TS buffer 312 is a buffer that temporarily stores the transport stream, which is transferred from the network 10, and is used as the aforementioned buffer (BUFF). The fill level of the TS buffer 312 is sent to the oscillation frequency control voltage generator 25.

The second buffer read-out unit 313 operates in sync with the clock signal that is generated from the clock generator 26. The second buffer read-out unit 313 reads out the transport stream from the TS buffer 312 in real time and sends it to the MPEG decoder (#2) 32.

Specifically, the second buffer read-out unit 313 reads out, in accordance with the clock signal, the transport stream, which is stored in the TS buffer 312, from the TS buffer 312 to the MPEG decoder (#2) 32 at a predetermined bit rate. The value of this bit rate is equal to the value of the frame rate at which the transport stream is to be reproduced. Thereby, whether the transport stream that is being received from the network 10 is a real-time stream such as broadcast data or a non-real-time stream from the storage medium 13, the transport stream is transmitted substantially in real time from the TS buffer 312 to the MPEG decoder (#2) 32 at a rate equal to the reproduction rate (frame rate) of the transport stream.

If each of the TS packets, which constitute the transport stream that is received from the network 19, is a TS packet with a time stamp (TTS packet: Time stamped Transport Stream packet), the second buffer read-out unit 313 determines the read-out timing of each TTS packet in accordance with the time stamp of each TTS packet stored in the TS buffer 312. Specifically, the second buffer read-out unit 313 is provided with a timing counter 314 that executes a counting operation in sync with the clock signal. The second buffer read-out unit 313 reads out from the TS buffer 312 a TS packet portion of that one of the TTS packets stored in the TS buffer 312, whose time stamp value agrees with the count value of the timing counter 314. Thereby, whether the transport stream that is currently being received from the network 10 is the real-time stream such as broadcast data or the non-real-time stream from the storage medium 13, the transport stream is transmitted in real time from the TS buffer 312 to the MPEG decoder (#2) 32 at a rate equal to the reproduction rate of the transport stream.

FIG. 11 shows an example of the structure of the MPEG decoder (#2) 32.

The MPEG decoder (#2) 32 comprises a demultiplexer (TS Demux) 321, a video buffer 322, a video decoder 323, an audio buffer 324, an audio decoder 325, a comparator 326, an STC counter 328 and a clock oscillator 327.

The demultiplexer (TS Demux) 321 executes a process for separating the transport stream, which is transferred from the TS reproduction process unit 31, into video data (video stream) and audio data (audio stream). This separating process is executed, for example, in units of a TS packet. The video data is stored in the video buffer 322, and the audio data is stored in the audio buffer 324. In addition, when the demultiplexer (TS Demux) 321 receives a TS packet including a PCR (Program Clock Reference), which is time reference information, from the transport stream reproduction process unit 31, the demultiplexer (TS Demux) 321 extracts PCR from the received TS packet. The extracted PCR is sent to the comparator 326.

The video decoder 323 reads out the video data from the video buffer 322 and decodes it. The decoding process of the video decoder 323 is executed in sync with the video clock of 27 MHz from the clock oscillator 327. The audio decoder 325 reads out audio data from the audio buffer 324 and decodes it. The decoding process by the audio decoder 325 is executed in sync with the audio clock from the clock oscillator 327.

The STC counter 328 executes a counting operation in sync with the clock signal of 27 MHz from the clock oscillator 327. The comparator 326 compares the count value of the STC counter 328 and the value of the PCR, and controls the oscillation frequency of the clock oscillator 327 on the basis of the comparison result so that the count value of the STC counter 328 may agree with the value of the PCR.

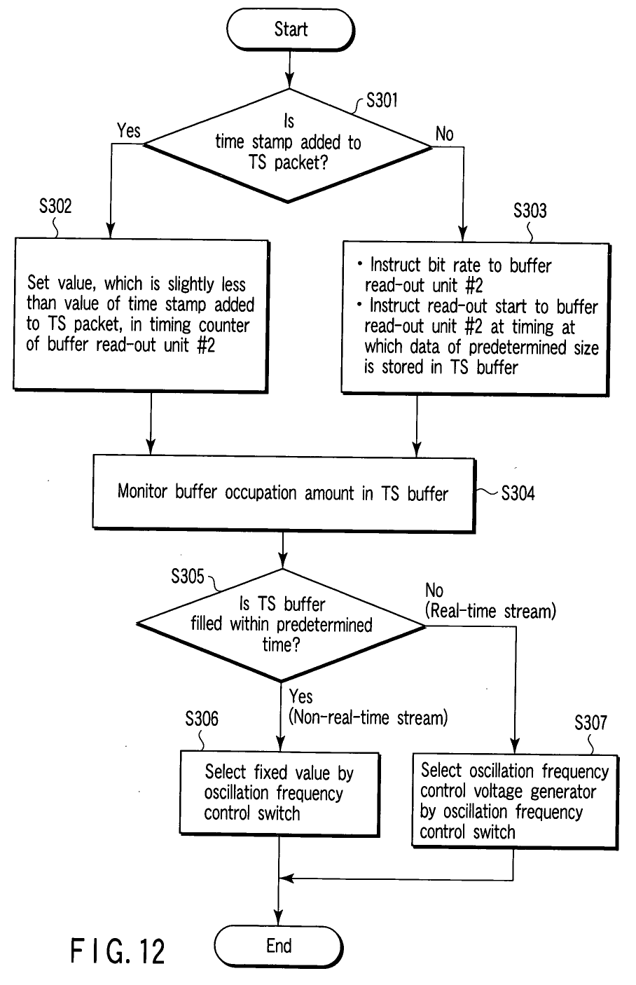

Next, referring to a flow chart of FIG. 12, a third example of the clock control process, which is executed by the system control unit 22, is described. This clock control process corresponds to the structure of the network client 21 shown in FIG. 9.

The system control unit 22 determines whether a time stamp is added to the TS packet that is received from the network 10 (step S301).

If a time stamp is added to the TS packet that is received from the network 10, that is, if the received TS packet is a TTS packet (YES in step S301), the system control unit 22 sets a value, which is less than the value of the time stamp added to the TS packet by a preset value, in the timing counter 314 of the second buffer read-out unit 313 so that the decoding process may be started in the state in which a certain amount of data is stored in the TS buffer 312.

On the other hand, if no time stamp is added to the TS packet that is received from the network 10, the system control unit 22 instructs the value of the bit rate, at which the transport stream is read out of the TS buffer 312, to the second buffer read-out unit 313, and also instructs the start of the read-out of the transport stream to the second buffer read-out unit 313 at the timing when data of a predetermined size is stored in the TS buffer 312 (step S303).

Subsequently, the determining unit 221 of the system control unit 22 monitors the fill level of the TS buffer 312, for example, the data amount (buffer occupation amount) in the TS buffer 312, and determines whether the TS buffer 312 is to be filled within a predetermined reference time from the start of the reception of the transport stream (step S304, S305). The value of the reference time is determined in accordance with the buffer size (capacity) of the TS buffer 312.

If the TS buffer 312 is filled within the reference time (YES in step S305), the determining unit 221 of the system control unit 22 determines that the stream that is currently being received is the non-real-time stream from the storage medium 13. In order to prevent the decoding operation speed of the MPEG decoder (#2) 32 from being abnormally accelerated, the clock control unit 222 of the system control unit 22 selects the fixed value by the oscillation frequency control switch 27 (step S306). Thereby, the frequency of the clock signal is kept at the fixed value.

If the TS buffer 312 is not filled within the reference time (NO in step S305), the determining unit 221 of the system control unit 22 determines that the stream that is currently being received is the real-time stream such as broadcast data. In order to adjust the frequency of the clock signal in accordance with the transmission timing of the real-time stream from the network server 1, the clock control unit 222 of the system control unit 22 selects the output of the oscillation frequency control voltage generator 25 by the oscillation frequency control switch 27 (step S307). Thereby, the frequency of the clock signal is made to correspond to the transmission timing of the real-time stream from the network server 11.

Alternatively, whether the stream that is being received is a non-real-time stream or a real-time stream may be determined, not on the basis of whether the TS buffer 312 is actually filled, but on the basis of whether the fill level of the TS buffer 312 exceeds a reference value within a predetermined time from the beginning of the reception of the real-time stream.

The second example of the procedure of the clock control process, which has been described with reference to the flow chart of FIG. 7, may be applied to the network client 21 shown in FIG. 9.

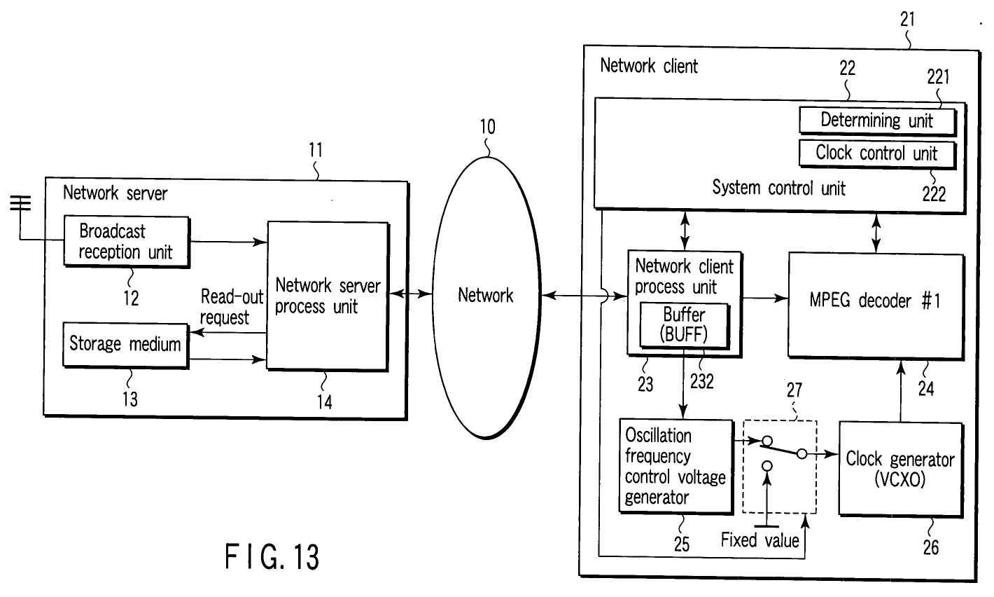

FIG. 13 shows a third example of the structure of the network client 21.

In this network client 21, the reception buffer 232 of the network client process unit 23 is used as the aforementioned buffer (BUFF), and the fill level of the reception buffer 232 is sent to the oscillation frequency control voltage generator 25. In the other respects, the structure of this network client 21 is the same as that shown in FIG. 1.

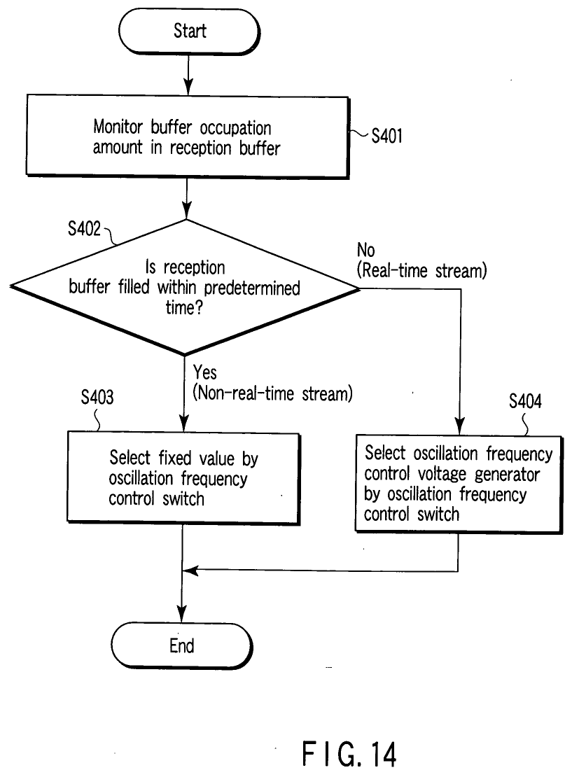

Next, referring to a flow chart of FIG. 14, a fourth example of the clock control process, which is executed by the system control unit 22, is described. This clock control process corresponds to the structure of the network client 21 shown in FIG. 13.

The determining unit 221 of the system control unit 22 monitors the fill level of the reception buffer 232 provided in the network client process unit 23, for example, the data amount (buffer occupation amount) in the reception buffer 232, and determines whether the reception buffer 232 is to be filled within a predetermined reference time from the start of the reception of the transport stream (step S401, S402). The value of the reference time is determined in accordance with the buffer size (capacity) of the reception buffer 232.

If the reception buffer 232 is filled within the reference time (YES in step S402), the determining unit 221 of the system control unit 22 determines that the stream that is currently being received is the non-real-time stream from the storage medium 13. In order to prevent the decoding operation speed of the MPEG decoder (#1) 24 from being abnormally accelerated, the clock control unit 222 of the system control unit 22 selects the fixed value by the oscillation frequency control switch 27 (step S403). Thereby, the frequency of the clock signal is kept at the fixed value.

If the reception buffer 232 is not filled within the reference time (NO in step S402), the determining unit 221 of the system control unit 22 determines that the stream that is currently being received is the real-time stream such as broadcast data. In order to adjust the frequency of the clock signal in accordance with the transmission timing of the real-time stream from the network server 1, the clock control unit 222 of the system control unit 22 selects the output of the oscillation frequency control voltage generator 25 by the oscillation frequency control switch 27 (step S404). Thereby, the frequency of the clock signal is made to correspond to the transmission timing of the real-time stream from the network server 11.

Alternatively, whether the stream that is being received is a non-real-time stream or a real-time stream may be determined, not on the basis of whether the reception buffer 232 is actually filled, but on the basis of whether the fill level of the reception buffer 232 exceeds a reference value within a predetermined time from the beginning of the reception of the real-time stream.

The second example of the procedure of the clock control process, which has been described with reference to the flow chart of FIG. 7, may be applied to the network client 21 shown in FIG. 13.

As has been described above, in the network client 21 of the embodiments, the clock control method is automatically changed on the basis of whether the stream, which is transferred from the network server 11 via the network 10, is a real-time stream or a non-real-time stream. Therefore, both the real-time stream and the non-real-time stream, which are transferred over the network 10, can correctly be reproduced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A reproduction apparatus which reproduces a stream including compression-encoded data, comprising:
a request sending unit which sends a request instructing transfer of the stream to a server over a network;
a receiving unit which receives the stream that is transferred from the server over the network;
a buffer which stores the received stream;
a decoder which executes a decoding process for reading out the received stream from the buffer and decoding the received stream;
a clock generator which generates a clock signal which determines a speed of the decoding process;
a determining unit configured to determine whether the received stream is a real-time stream, which is transmitted in real time from the server at a transmission rate corresponding to the received stream, or a non-real-time stream, which is stored in a storage medium of the server and can be transmitted from the server at a higher rate than the transmission rate corresponding to the received stream; and
a clock control unit configured to execute a process for varying a frequency of the clock signal in accordance with a fill level of the buffer if the received stream is the real-time stream, and to execute a process for setting the frequency of the clock signal at a fixed value if the received stream is the non-real-time stream.

2. The reproduction apparatus according to claim 1, wherein the determining unit is configured to determine whether the received stream is the real-time stream or the non-real-time stream, based on whether the fill level of the buffer exceeds a reference value within a predetermined time from starting of the reception of the stream.

3. The reproduction apparatus according to claim 1, further comprising a demultiplexer which separates the received stream into audio data and video data,
wherein the buffer is an audio buffer which stores the separated audio data, and the determining unit determines whether the received stream is the real-time stream or the non-real-time stream, based on whether the fill level of the audio buffer exceeds a reference value within a predetermined time from starting of the reception of the stream.

4. The reproduction apparatus according to claim 3, wherein the audio data is compression-encoded by fixed-bit-rate encoding.

5. The reproduction apparatus according to claim 1, further comprising a read-out unit which operates in sync with the clock signal and reads out the received stream from the buffer to the decoder at a specified bit rate,
wherein the determining unit determines whether the received stream is the real-time stream or the non-real-time stream, based on whether the fill level of the buffer exceeds a reference value within a predetermined time from starting of the reception of the stream.

6. The reproduction apparatus according to claim 1, wherein the received stream is a transport stream that includes packets, to each of which a time stamp is added,
the reproduction apparatus further comprises a read-out unit, which includes a counter that executes a counting operation in sync with the clock signal, the read-out unit reading out that one of the packets stored in the buffer, whose time stamp has a value equal to a count value of the counter, from the buffer to the decoder, and
the determining unit determines whether the received stream is the real-time stream or the non-real-time stream, based on whether the fill level of the buffer exceeds a reference value within a predetermined time from starting of the reception of the stream.

7. The reproduction apparatus according to claim 1, wherein the compression-encoded data is transferred from the server by packets each including a header portion and a payload portion, and one of the header portion and the payload portion of each of the packets includes identification information that is indicative of whether the compression-encoded data is the real-time stream or the non-real-time stream, and
the determining unit determines whether the received stream is the real-time stream or the non-real-time stream, based on the identification information.

8. A method of controlling a decoding process for decoding compression-encoded data, comprising:
sending a request instructing transfer of a stream, which includes the compression-encoded data, to a server over a network;
receiving the stream which is transferred from the server over the network;
executing a decoding process, in sync with a clock signal, for reading out the received stream from a buffer which stores the received stream and decoding the received stream;
determining whether the received stream is a real-time stream, which is transmitted in real time from the server at a transmission rate corresponding to the received stream, or a non-real-time stream, which is stored in a storage medium of the server and can be transmitted from the server at a higher rate than the transmission rate corresponding to the received stream;
executing a process for varying a frequency of the clock signal in accordance with a fill level of the buffer if the received stream is the real-time stream; and
executing a process for setting the frequency of the clock signal at a fixed value if the received stream is the non-real-time stream.

9. The method according to claim 8, wherein the determining determines whether the received stream is the real-time stream or the non-real-time stream, based on whether the fill level of the buffer exceeds a reference value within a predetermined time from starting of the reception of the stream.

10. The method according to claim 8, further comprising separating the received stream into audio data and video data,
wherein the buffer is an audio buffer which stores the separated audio data, and the determining determines whether the received stream is the real-time stream or the non-real-time stream, based on whether the fill level of the audio buffer exceeds a reference value within a predetermined time from starting of the reception of the stream.

11. The method according to claim 10, wherein the audio data is compression-encoded by fixed-bit-rate encoding.

12. The method according to claim 8, wherein the decoding process includes a process of reading out, in sync with the clock signal, the received stream from the buffer at a specified bit rate, and
the determining determines whether the received stream is the real-time stream or the non-real-time stream, based on whether the fill level of the buffer exceeds a reference value within a predetermined time from starting of the reception of the stream.

13. The method according to claim 8, wherein the received stream is a transport stream that includes packets, to each of which a time stamp is added,
the decoding process includes a read-out process of reading out, from the buffer, that one of the packets stored in the buffer, whose time stamp has a value equal to a count value of a counter that executes a counting operation in sync with the clock signal, and
the determining determines whether the received stream is the real-time stream or the non-real-time stream, based on whether the fill level of the buffer exceeds a reference value within a predetermined time from starting of the reception of the stream.

14. The method according to claim 8, wherein the compression-encoded data is transferred from the server by packets each including a header portion and a payload portion, and one of the header portion and the payload portion of each of the packets includes identification information which is indicative of whether the compression-encoded data is the real-time stream or the non-real-time stream, and
the determining determines whether the received stream is the real-time stream or the non-real-time stream, based on the identification information.
